(19) United States
(12) Patent Application Publication
(10) Pub. No.: US 2006/0212412 A1
(43) Pub. Date: Sep. 21, 2006

(54) Methods and systems for induction and use of probabilistic patterns to support decisions under uncertainty

(75) Inventor: Marina Sapir, Mamaroneck, NY (US)

Correspondence Address: MINTZ LEVIN COHN FERRIS GLOVSKY & POPEO, 666 THIRD AVENUE, NEW YORK, NY, 10017, US

(73) Assignee: Aureon Laboratories, Inc., Yonkers, NY (US)

(21) Appl. No.: 11/340,178

(22) Filed: Jan. 25, 2006

Related U.S. Application Data
(60) Provisional application No. 60/646,810, filed on Jan. 25, 2005.
(60) Provisional application No. 60/647,832, filed on Jan. 27, 2005.
(60) Provisional application No. 60/679,381, filed on May 9, 2005.

(51) Int. Cl. G06F 15/18

(52) U.S. Cl. 706/12

(57) ABSTRACT

Methods and systems are provided for the induction and use of probabilistic patterns in data to support decisions under uncertainty. In an aspect, the proposed approach both suggests a decision and justifies the suggestion in a convenient form for an end-user (e.g., a physician). At least one probabilistic pattern of the form B(x)→C may be generated based on data for cases with known classification. Pattern-coded data may be generated for the known cases and for another case (e.g., a test case or a new case), by evaluating the data for the known cases and other case with the at least one probabilistic pattern. A classification decision may be made for the test case by subjecting the pattern-coded data to, for example, an ordering and ranking procedure or a voting procedure. Because the probabilistic patterns are readily interpretable, the end-user can verify the validity of both the patterns and the decision.

### CROSS REFERENCE TO RELATED APPLICATIONS

This claims the benefit of U.S. Provisional Patent Application Ser. Nos. 60/646,810, filed Jan. 25, 2005, 60/647,832, filed Jan. 27, 2005, and 60/679,381, filed May 9, 2005, which are hereby incorporated by reference herein in their entireties.

### FIELD OF THE INVENTION

Embodiments of the invention relate to methods and systems for the induction and use of probabilistic patterns in data to support decisions under uncertainty. In an aspect, the proposed approach both suggests a decision and justifies the suggestion in a convenient form for an end-user.

### BACKGROUND OF THE INVENTION

In many applications, decisions need to be made under conditions of uncertainty, where there is no way of arriving at a correct solution every time. The decision-making process involves finding probabilistic rules that associate descriptions of known cases with the decisions made in the cases, to improve the chances of making a correct decision in new cases. For example, physicians may study cases of patients with confirmed diagnosis to find typical phenotypes of a certain disorder, to improve the diagnostics of the disorder in the future. Very often, computer systems are used to assist this activity.

Computer algorithms for supporting decisions under uncertainty have been developed in the area of machine learning. Generally, machine learning methods (e.g., support vector machines (SVM) and neural networks) generate a mathematical model that defines dependencies between the descriptive data and classes (i.e., outcomes) of known cases. The mathematical model is then applied to the description of a new case in order to make a decision about its class. Because these mathematical models involve complex mathematical relationships, justification of decisions by the models is not transparent to end-users. For example, in order to use machine learning methods, physicians have to completely trust the mathematical model and not rely on their own expertise and training.

In view of the foregoing, it would be desirable to provide methods and systems that use a transparent, probabilistic logical model to support decisions under uncertainty. For example, it would be desirable to provide methods and systems that assist physicians in making medical decisions without precluding the physicians from using their expertise and training to arrive at final determinations.

### SUMMARY OF THE INVENTION

Embodiments of the invention relate to methods and systems for the induction and use of logical probabilistic patterns to support decisions under uncertainty. For example, the present invention may be used in the medical field to generate patterns that associate patients' characteristics with one or more diagnoses, and to use these patterns to diagnose new patients. As another example, the present invention may be used to determine an appropriate course of treatment for a patient, based on patterns derived from the data of other patients who may have similar medical conditions and who underwent medical treatments with known outcomes. In other examples, the present invention may assist in finding geological and geophysical patterns associated with iron ores, and so on.

In an embodiment, the invention may include two main aspects: inducing patterns and using the patterns to make decisions under uncertainty. The induction aspect finds patterns in data characterizing known cases. The decision-making aspect may include three distinct procedures: coding, scoring, and classification. The coding procedure codes the known cases and a test case by the pattern(s) the cases exhibit. The scoring procedure uses the pattern-coded data to generate a score for the new case. The classification procedure makes a decision about the new case based on its score.

In an aspect of the present invention, at least one probabilistic pattern of the form B(x)→C is generated based on data for cases with known classification, where B(x) includes at least one condition on a variable, and C is an outcome associated with the at least one condition. Pattern-coded data is generated for both the known cases and another case (e.g., a test case or a new case), by evaluating the data for the known cases and the other case with the at least one probabilistic pattern. A classification decision is made for the other case by subjecting the pattern-coded data to, for example, an ordering and ranking procedure or a voting procedure.

In one embodiment, the present invention may generate the patterns by identifying the rules that have the highest value of a statistical criterion amongst rules comparable by generality. Thus, generally, a pattern is a rule that satisfies some criterion. The statistical criterion determines whether rules of the form B(x)→C in the known data are statistically significant. The rule Y=B₁(x)→C for a given class is said to be more general than the rule Z=B₂(x)→C for the same class if every instance satisfying the conditions B₂(x) must satisfy the conditions B₁(x) as well. Two rules are said to be comparable by generality if one of them is more general than the other one. It can be said that a rule Y is preferable to a rule Z, that is Y>>Z, if: (i) the rules Y and Z are comparable by generality; and (ii) either the statistical criterion value of Y is greater than the statistical criterion value of Z, or Y and Z have equal criterion values and Y is more general than Z.

In one embodiment, a procedure is provided that identifies the set of patterns M (“digest”) for a given class that meet the following criteria: (i) for every rule X in the entire set of rules G in the known data, there exists a pattern Y in the digest M such that Y>>X; and (ii) no two patterns in M are comparable by generality.

In another embodiment, a procedure is provided that approximates the above-described procedure for identifying the digest of patterns. The result of the approximation is that the procedure may identify some rules of the digest, but also some rules that would not have been selected by the unabbreviated procedure for finding M. The approximation procedure may require less computational resources than the procedure for identifying the digest. In an aspect, the identified patterns can be subject to additional filtering procedures.

In one example, the present invention evaluates probabilistic rules through the use of a z-test criterion that can be calculated by the equation:

$$z = \frac{{p}_{1} - p}{\sqrt{p ( 1 - p ) ( 1 / {n}_{1} + 1 / n )}}$$

where
n₁ is number of cases of the class C that satisfy the premise B(X);
n is to total number of known cases;
p₁ is the proportion of the known cases of class C that satisfy the premise B(X); and
p is the proportion of the known cases that actually belong to class C.

In another example, the present invention evaluates probabilistic rules through the use of a chi-squared (chi2) criterion that can be expressed by the equation:
chi2=n..(|n₁₁n₂₂−n₁₂n₂₁|−0.5n..)²/n_{1.}n_{2.}n.₁n.₂
where
n₁₁ is number of cases of the class C that satisfy the premise B(X);
n₁₂ is number of cases of other class(es) that satisfy the premise B(X);
n₂₁ is number of cases of the class C in the cohort;
n₂₂ is number of cases of other class(es) in the cohort;
n_{1.} is number of cases that satisfy the premise B(X);
n_{2.} is total number of cases in the cohort;
n.₁=n₁₁+n₂₁
n.₂=n₁₂+n₂₂
n..=n₁₁+n₂₁+n₁₂+n₂₂

In yet another example, the present invention evaluates probabilistic rules through the use of the following criteria:
1. The proportion μ(B, C) is above the threshold h, where μ(B, C) can be expressed by the equation:

$$μ ( B , C ) = \frac{‖ B ( x ) ⋂ C ‖}{‖ B ( x ) ‖} ; μ ( B , C ) \geq h$$
2. The proportion ν(B, C) is above the threshold g, where ν(B, C) can be expressed by the equation:

$$ν ( B , C ) = \frac{‖ B ( x ) ⋂ C ‖}{‖ C ‖} ; ν ( B , C ) \geq g$$

An additional criterion may also limit the number of conditions in a rule to k, where h, g, and k are constants.

### BRIEF DESCRIPTION OF THE DRAWINGS

For a better understanding of the present invention, reference is made to the following description, taken in conjunction with the accompanying drawings, in which like reference characters refer to like parts throughout, and in which:

FIG. 1 is a flowchart of illustrative stages involved in the induction and use of logical probabilistic patterns to support decisions under uncertainty in accordance with the present invention;

FIGS. 2(a) and 2(b) show illustrative probabilistic patterns in accordance with the present invention, in which the pattern in FIG. 2(a) associates multiple conditions with a first classification and the pattern in FIG. 2(b) associates a single condition with a second classification;

FIG. 3 shows pattern-coded data for first and second cases in accordance with the present invention; and

FIG. 4 is a flowchart of illustrative stages involved in generating pattern-coded data by evaluating data for a case with probabilistic patterns in accordance with the present invention.

### DETAILED DESCRIPTION OF THE INVENTION

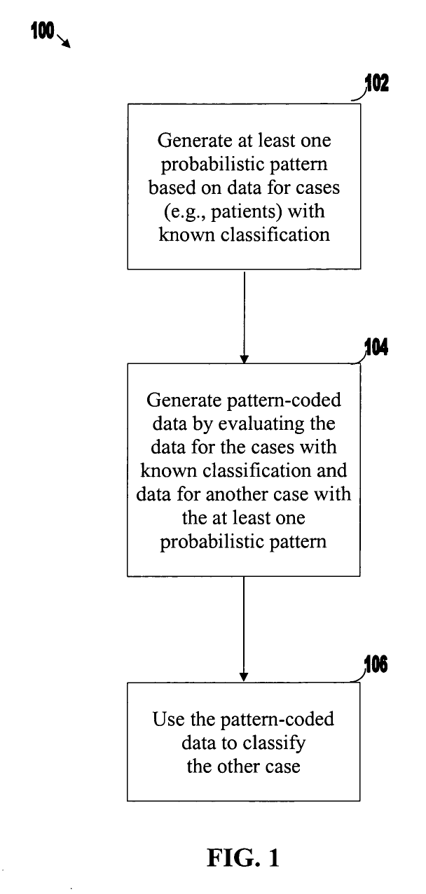

FIG. 1 is a flowchart of illustrative stages involved in the induction and use of logical probabilistic patterns to support decisions under uncertainty. At stage 102, one or more patterns are generated based on data for cases (e.g., patients) with known classification. For example, the data for a known case may include values for variables (features) for that case. The patterns are probabilistic (i.e., not deterministic) in the sense that they may not be 100% true for all cases in a cohort. The patterns are expressed generally in the form B(x)→C, and more particularly in the form:
t₁(x₁) &t(x₂) & . . . &tₙ(xₙ)→Cᵢ (1)
where x₁, . . . , xₙ, are descriptive variables, t₁, . . . ,tₙ, are conditions on the variables, and Cᵢ is a given class. The left part of the pattern (1) may be referred to as a premise, and the right part may be referred to as a conclusion. If the values for the variables of a case satisfy the conditions of the pattern, the case is likely to have the given classification of the pattern. A descriptive variable may allow only fixed types of conditions. For example, continuous variables may allow any inequalities (e.g., a <x <b) and nominal variables may allow equalities only (x=a). In various applications, other types of conditions may be used as the meaning of the variable allows. A rule A is said to be more general than a rule B, if every case satisfying the premise of the rule B must satisfy the premise of the rule A as well, and the conclusions of rules A and B coincide.

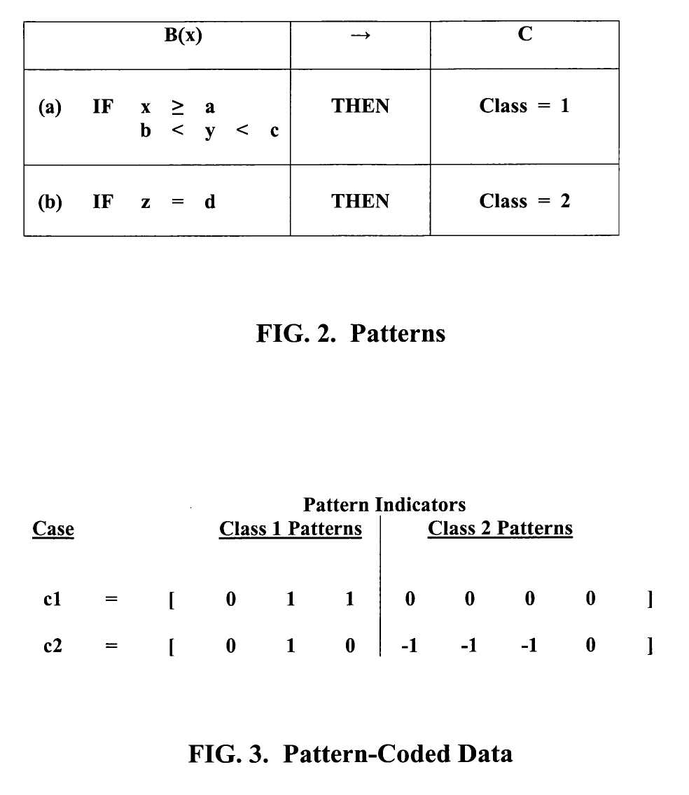

For example, FIGS. 2(a) and 2(b) show illustrative probabilistic patterns in accordance with the present invention. The pattern of FIG. 2(a) indicates that a case is likely to have a first classification if the data for the case meets the conditions on variables x and y that x≧a and b<y<c, where a, b, and c are constants. The pattern of FIG. 2(b) indicates that a case is likely to have a second classification if the data for the case meets the conditions on variable z that z=d, where d is a constant. Additional patterns for one or both of the first and second classes and/or patterns for other classes may be generated at stage 102, although only one pattern for each of the first and second classes has been shown in FIG. 2 to avoid overcomplicating the drawing.

Each rule may be characterized by the strength of the association between its premise and conclusion. In a preferred embodiment, the present invention selects the most general rules with the strongest associations as the probabilistic patterns used for the classification. Generally, the strength of the association may be determined based on a statistical criterion that compares the proportion of (i) the number of cases of the selected class in the cohort that satisfy the premise of the rule to (ii) the total number of cases of the selected class in the cohort. The association is said to be significant if the value of the criterion is above a given threshold of significance for the criterion.

In one example, a z-test criterion may be used to measure the strength of association of a rule B(X)→C, where the z-test criterion can be calculated by the equation:

$$z = \frac{{p}_{1} - p}{\sqrt{p ( 1 - p ) ( 1 / {n}_{1} + 1 / n )}}$$

where
n₁, is number of cases of the class C that satisfy the premise B(X);
n is to total number of known cases;
p₁ is the proportion of the known cases of class C that satisfy the premise B(X); and
p is the proportion of the known cases that actually belong to class C.This z-test criterion is described in [1]. For example, suppose that the threshold of significance for this criterion is selected as epsilon =0.05, the table in [1] shows that the minimum z-test value that meets this threshold is 1.95. If the threshold is set equal to epsilon =0.005, the minimum z-test value that meets this threshold is 2.8.

In another example, a chi-squared criterion (chi2) may be used to measure the strength of association of a rule B(X)→C, where chi2 can be calculated by the equation:
chi2=n..(|n₁₁n₂₂−n₁₂n₂₁|−0.5n..)²/n_{1.}n_{2.}n.₁n.₂ (2)
where
n₁₁ is number of cases of the class C that satisfy the premise B(X);
n₁₂ is number of cases of other class(es) that satisfy the premise B(X);
n₂₁ is number of cases of the class C in the cohort;
n₂₂ is number of cases of other class(es) in the cohort;
n_{1.} is number of cases that satisfy the premise B(X);
n_{2.} is total number of cases in the cohort;
n.₁=n₁₁ +n₂₁
n.₂=n₁₂ +n₂₂
n..=n₁₁+n₂₁+n₁₂+n₂₂
   The patterns found in the known data may be the rules that have:
(1) a stronger association (i.e., a higher value for chi2) than any more general rule;
(2) no weaker of an association than any less general rule; and
(3) a significant association with the conclusion.
   Additional details regarding using the chi-squared criterion to select patterns from the data for the known cases are described below.

In yet another example, statistical criteria including parameters h, g, and k, which are constants specified by a user, may be used to determine the strength of association of a rule B(X)→C. Particularly, the rule may be said to be significant if the rule satisfies the following three criteria:
1. The proportion μ(B, C) is above the threshold h, where this proportion is equal to a) the number of cases of the class C in the cohort that satisfy the premise B(X) divided by b) the total number of cases in the cohort that satisfy the premise B(X). This is a requirement that the premise is primarily a predictor for the class C and not some other class(es).

$$μ ( B , C ) = \frac{‖ B ( x ) ⋂ C ‖}{‖ B ( x ) ‖} ; μ ( B , C ) \geq h$$
2. The proportion v(B, C) is above the threshold g, where this proportion is equal to (i) the number of cases of the class C in the cohort that satisfy the premise B(X) divided by (ii) the total number cases of the class C in the cohort. This is a requirement that the premise is a predictor for at a significant proportion of the cases of the class C in the cohort.

$$ν ( B , C ) = \frac{‖ B ( x ) ⋂ C ‖}{‖ C ‖} ; ν ( B , C ) \geq g$$
3. The number of non-trivial intervals in the rule B does not exceed k. Generally, this limits the number of conditions that can be included in the premise. A more detailed description of non-trivial intervals is provided below.
   Additional details regarding using the statistical criteria including parameters h, g, and k to select patterns from the data for the known cases are described below, and in [2], [3], and [4]. Notably, [2], [3], and [4] do not disclose generating pattern-coded data from the probabilistic patterns, nor do these references disclose using such pattern-coded data to classify a case.

At stage 104, pattern-coded data is generated by evaluating the data for the cases with known classification and data for the other case with the probabilistic patterns generated at stage 102. Particularly, a pattern-coded dataset is generated for each case based on the values of the variables for that case. For each pattern, it is determined whether the values for the case satisfy the premise of the pattern. The result of each determination is represented by an associated indicator in the pattern-coded dataset for the case. Suppose, for example, the cohort has only two classes. If a case satisfies the premise of a pattern of the first class, the value of the corresponding indicator for that pattern is set equal to 1 for the case. If a case satisfies the premise of a pattern of the second class, the value of the corresponding indicator is set equal to −1 for the case. If a case does not satisfy the premise of a pattern, the value of the associated indicator is set equal to 0 for the case. For cohorts that have 3 or more classes, patterns can be induced and decisions under uncertainty can be made by, for example, solving a series of two-class problems that distinguish the first class from the other classes, the second class from the other classes, and so on.

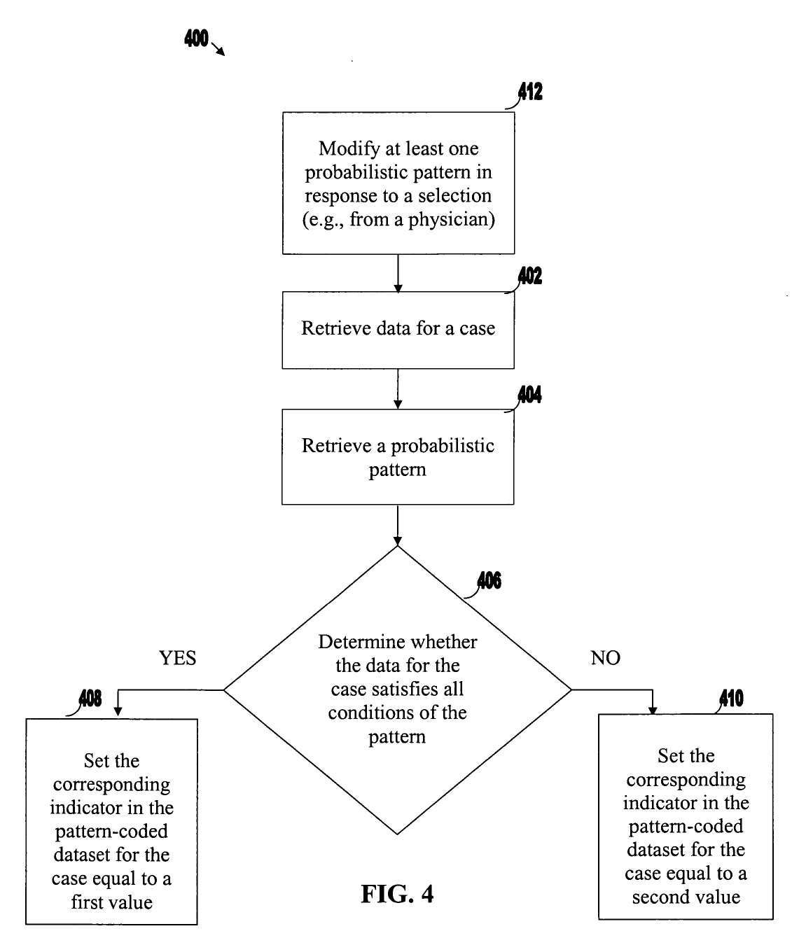

For example, FIG. 3 shows pattern-coded data (e.g., data vectors) for first and second cases c1 and c2, where each dataset has three indicators that correspond to patterns of a first class and four indicators that correspond to patterns of a second class. As shown, case c1 satisfies the premises of the second and third patterns of class 1, but none of the other patterns. Case c2 satisfies the premises of the second pattern of class 1, and the first, second, and third patterns of class 2, but none of the other patterns. Such pattern-coded data may be generated using the stages shown in FIG. 4. At stages 402 and 404, respectively, data for a case and a pattern are retrieved from, for example, one or more electronic databases in memory. At stage 406, a determination is made whether the data for the case satisfies all the conditions of the pattern. If the data satisfies all the conditions, the value of the corresponding pattern indicator in the pattern-coded dataset for the case is set equal to a first value at stage 408. If the data satisfies less than all the conditions, the value of the corresponding pattern indicator in the pattern-coded dataset for the case is set equal to a second value at stage 410. This process may be repeated until the data for all of the known cases has been evaluated by all the patterns, to produce pattern-coded datasets for all of the known cases. As shown in FIG. 4, optional stage 412 may be included in which at least one of the patterns is modified (e.g., deleted) before the patterns are used to generate the pattern-coded data. For example, because the probabilistic patterns generated at stage 102 are readily interpretable (i.e., the associations between the premises and conclusions of the patterns are transparent), a physician can use his/her expertise and training to verify the validity of these associations.

At stage 106, the pattern-coded data is used to classify the other case. In one example, the pattern-coded data may be subject to a multi-dimensional partial ordering and ranking procedure in order to classify the other case. Multi-dimensional partial ordering and ranking is introduced in [5] and [6]. The partial order for any two pattern-coded cases is defined as follows: if, for every pattern indicator, the value of the indicator of the first case is larger than or equal to the value of the indicator for a second case, and the first case has at least one value for a pattern indicator that is higher than the corresponding value for the second case, the first case is “higher” than the second case (the second case is “lower” than the first case). Therefore, case c1 in FIG. 3 is higher than case c2. When these conditions are not met between two cases, neither of the two cases can be said to be higher or lower than the other. The rank of a given case is defined as the difference between (i) the number of the cases lower than the given case and (ii) the number of the cases higher than the given case. Thus, this procedure can be applied in order to make a classification decision for the other case, by ordering and ranking the pattern-coded data for the case against the pattern-coded data for the cases with known classification. For example, the other case can be classified as belonging to class 1 if its rank (score) is above or equal to 0, otherwise it can be classified as belonging to class 2. As another example, a threshold (e.g., a non-zero threshold) for classifying the other case based on its rank may be selected from multiple potential thresholds. For example, based on a criterion of classification quality (e.g., the sum or product of sensitivity and specificity), the cut point of the rank of the training cases that provides the highest value of classification quality may be selected as the threshold.

In another example, the pattern-coded data may be subject to a “voting” procedure in order to classify the other case. A score is calculated for each of the known cases by subtracting the number of patterns of the second class from number of patterns of the first class that the case exhibits. A threshold value for this score (not necessarily zero) that separates cases of the first class from cases of the second class may then be found on the training set to achieve optimal sensitivity and specificity. Thus, in order to classify the other case, the score for the other case can be determined and then compared to the threshold. Cases with scores higher (lower) than the threshold are classified as belonging to the first (second) class. It should be noted that this method may have an advantage over the partial ordering and ranking procedure described above, when the distribution by class of cases from the set of known cases is not representative of the distribution by class in the general population.

Additional details regarding stage 102 of generating probabilistic patterns will now be provided. An order of the rules in the known data is defined in such a way that the search for patterns may be accelerated by skipping some rules which are not general enough to pass a threshold of significance (e.g., epsilon =0.05), as measured by the strength of association between premise and conclusion of the rules.

Without restricting generality, only rules that contain a condition (trivial or non-trivial) for every variable may be searched. The order of the search for rules is defined hierarchically. On the first level, the order of the possible conditions for rules is defined for each variable. The main requirement for the first level order is that if a condition t₁(x) is more general than condition t₂(x), the condition t₁(x) precedes the condition t₂(x). As an example of such a first level order, consider the case when the allowed conditions are two-sided inequalities. In this instance, it makes sense to test only inequalities a≦x≦b with limits a and b taken from the actual values of the variable x in the data for the known cases. The inequality a≦x≦b is referred to as the trivial condition for the variable x if a is the minimal value of the variable x in the dataset and b is maximal value of the variable x in the dataset, since all broader inequalities will be equivalent to this one with respect to the known dataset. Within this order, the inequalities can be ordered by the limit (a) first, and by the limit (b) second, or vice versa. The relative order between variables may be taken as the order in which the variables appear in data records of the dataset. On the second level, the order is defined as follows: if the premise D(X) has the same conditions for the variables x₁, . . . ,xₖ as the premise E(X), but the condition for the variable xₖ₊₁ in the premise D(X) precedes the condition for the same variable in E(X), the premise D(x) precedes the premise E(x) in the proposed order.

Denote tr(x) the trivial condition which is true for all values of the variable x. If a premise does not contain a condition for a variable, it has an equivalent premise with the trivial condition for this variable. Therefore, one can consider only premises with conditions on all variables. Since the trivial condition is the most general one, the proposed order has the trivial condition first for each variable, and the trivial premise Tr(X)=tr(xl)& . . . &tr(xn) is the first premise in the proposed order. For a premise A, denote A′ the premise which follows immediately after the premise A in the defined order. Define a chain to be to the maximal sequence of premises that immediately follow each other in the defined order and that are comparable by generality. A chain ends (and a new chain begins) when A′ is not less general than A.

The concepts of generality of rules and trivial conditions are illustrated in the following example. Given the following rules B(X)→C:
(1) (any status of headache) & (temperature>98) & (runny nose=yes)→(diagnosis=flu)
(2) (headache=yes) & (temperature>101) & (runny nose=yes)→(diagnosis=flu)
(3) (headache=yes) & (any temperature) & (runny nose=yes)→(diagnosis=flu)
   It is observed that rule (1) is more general than rule (2) because every instance satisfying the conditions of (1) must satisfy the conditions of (2) as well. In other words, every condition of (1) is either less restrictive or no more restrictive than the corresponding condition in (2). The condition “any status of headache” in (1) illustrates a trivial condition, because it does not impose any restriction whatsoever. Based on the criterion for generality, it is also observed that rule (3) is more general than rule (2) and that rules (1) and (3) are not comparable by generality.

In an aspect, the present invention identifies the rules that have the highest value of a statistical criterion amongst rules that are comparable by generality. As described above, two rules are said to be comparable by generality if one of them is more general than the other one. It can be said that a rule A is preferable to a rule B, that is A>>B, if: (i) the rules A and B are comparable by generality; and (ii) either the criterion value of A is greater than the criterion value of B, or A and B have equal criterion values and A is more general than B.

In one embodiment, a procedure is provided that identifies the set of patterns M (“digest”) for a given class that meet the following criteria: (i) for every rule X in the entire set of rules G from the known data, there exists a pattern Y in the digest M such that Y>>X; (ii) no two patterns in M are comparable by generality; and (iii) any pattern in the digest is statistically significant with a selected significance level. Given a statistical criterion (e.g., z-test or chi2) and a threshold of significance (e.g., epsilon=0.05), it can be shown that the digest M exists and is unique. Generally, it can be said that the digest includes all essential knowledge that can be learned from the known data in the most compact form.

The concept of the chain helps explain the advantage of the order on premises described above. Suppose, the z-test is used as a validity criterion and that, based on the selected threshold of significance, it is determined that premises must satisfy a given lowest admissible value of this criterion. Then, based on the number of known cases and the proportion of each class in the dataset, the smallest number of cases satisfying a premise that will produce the admissible validity can be calculated (by inserting the known values into the criterion and solving the equation for the unknown variable that represents the number of cases satisfied by the premise). For example, denote α1 and α2 the minimal number of cases of the admissible premises for the first and second classes. As the procedure for searching for the digest proceeds by navigating the premises in the order described above, as soon the size of the block becomes smaller than the minimal of the numbers α1 and α2, the procedure can switch to the next chain, without finishing the search on the given chain. The end of the chain with the premises that fall below the lower limit will be called thin. Skipping the thin ends of chains can lower the search time significantly.

The procedure for identifying the patterns of the digest is as follows: given the statistical criterion and threshold of significance:
1. Determine a criterion value for every rule B(x)→C in the space G of all such rules, skipping the ends of chains;

Exclude all the identified rules from G that have criterion values less than the minimum criterion value specified by the threshold of significance (if this leaves an empty set in G, the procedure ends);

Determine a criterion value for every rule remaining in G, skipping thin ends of chains;

Identify the set T of one or more rules with the highest criterion value on G;

Exclude the set T from G.
2. Identify the subset T′ of all the most general rules in T. Store this subset T′ as patterns in the digest.
3. Exclude all rules comparable by generality with T′ from the search set G.
4. If the set G is not empty, repeat the steps 1-3 above (with the exception that the filtering based on the threshold of significance need not be repeated).
   This procedure can be repeated for each class.

In another embodiment, a procedure is provided that approximates the above-described procedure for identifying the digest of patterns. The result of the approximation is that the procedure may select as patterns some rules that are included in the digest, but some rules that are not. Typically, the patterns selected by the approximation will not meet the second requirement of the digest, because some of the selected patterns will be comparable by generality. The approximation procedure may use a short memory and a long memory. The short memory stores information about one premise and the measure of its association with the conclusion (class). Long memory stores the premises of the rules selected as patterns for the class, in addition to the strengths of association of those premises. At the start of the procedure, the long memory is an empty set. As with the procedure for identifying the digest, the approximation procedure searches for rules that have a fixed conclusion C, and that have a strength of association with the conclusion C that is stronger than the strength of association with the conclusion specified by the significance threshold. However, as described below, the approximation procedure compares the criterion values of rules within the same chain, and selects the rule with the highest value (even though there may be rules comparable by generality in other chains). This approximation procedure is as follows: starting with the first chain that includes the trivial premise:
1. Determine the rule (if any) on the current chain that (i) has a value of the statistical criterion above the significance threshold and (ii) that has the maximal value of the statistical criterion in the chain. Store the rule as a pattern in long memory.
2. Repeat stage 1 on the next chain.
   This procedure repeats until all chains have been evaluated. The procedure is repeated for each class.

The following is another procedure for generating probabilistic patterns from the data for the known cases, in which the above-described criteria including parameters h, g, and k are used to determine the strength of association between the premises and conclusions of the rules. Denote W the current premise under examination in the order of premises, starting with the trivial premise. Denote M the current set of premises which satisfy the criteria including parameters h, g, and k, where M is empty at the start of the procedure. At the end of the procedure, M includes all the premises of the patterns for the class under consideration. The procedure may be repeated for each class to generate all the patterns for all the classes. As described above, the parameters h, g, and k are selected by a user before the procedure is performed. A different combination of parameters h, g, and k may or may not be selected for each class (e.g., in order to make the criteria for a given class more conservative than the criteria for another class).
1. If (ν(W)<g), this indicates that the current premise does not meet the criteria for significance, and that none of premises less general than the current premise can meet the criteria. Thus, skip all of the less general premises in the current chain, take the first premise in the next chain, and restart at stage 1.
2. If (ν(W)>g and μ(W)>h), this indicates that the current premise meets the criteria for significance. Store the current premise in the set M if M does not already contain a premise more general than the current premise. Skip all of the premises less general than the current premise in the order, take the following premise in the order, and restart at stage 1.
3. If (ν(W)>g and μ(W)<h), this indicates that current premise does not meet the criteria for significance, but that a less general premise may meet the criteria. Thus, take the next premise in the order and restart at stage 1.

In some embodiments, patterns selected by the above-described procedures from the full set of possible rules in the known data can be subject to additional filtering procedures. For example, one filtering procedure may be used that determines whether any premise of the selected patterns includes an unnecessary condition. This can be determined by replacing the condition with the trivial condition for that variable, and determining whether the statistical criterion value for the new premise changes significantly. If no significant change is observed (based on some predefined criteria), the condition may be replaced with the trivial condition in the selected pattern. The comparison may be based on, for example, the z-test criterion: suppose, C1 is a premise obtained by replacing one of the non-trivial intervals in premise C with the trivial one. Denote p proportion of the class c satisfying the premise C and p1 the proportion of the class c satisfying the premise C1. If, according to the z-test, (i) it is determined that the difference between p and p1 is significant and (ii) that the z-test value of the premise C is higher, the premise C passes the filter without loss of the non-trivial condition.

In another example, a filtering procedure may be performed that determines whether a given pattern from the set of selected patterns for a given class adds meaningful information to the other patterns. For each pattern, the set of instances may be determined that satisfy the premise of the given pattern but that do not satisfy the premises of any of the other selected patterns. If this set contains only instances of the other class(es), the given pattern can be excluded from the set of patterns by the filter.

In yet another example, a filtering procedure may be performed that ensures that no pattern from the selected set of patterns is more general than another pattern in the set (this procedure will be unnecessary when the set of patterns is the digest because, by definition, no patterns in the digest are comparable by generality).

Insofar as embodiments of the invention described above are implementable, at least in part, using a computer system, it will be appreciated that a computer program for implementing at least part of the described methods is envisaged as an aspect of the present invention. The computer system may be any suitable apparatus, system or device. For example, the computer system may be a programmable data processing apparatus, a general-purpose computer, a Digital Signal Processor or a microprocessor. The computer program may be embodied as source code and undergo compilation for implementation on a computer, or may be embodied as object code, for example.

It is also conceivable that some or all of the functionality ascribed to the computer program or computer system aforementioned may be implemented in hardware, for example by means of one or more application specific integrated circuits.

Suitably, the computer program can be stored on a carrier medium in computer usable form, which is also envisaged as an aspect of the present invention. For example, a computer readable medium may be encoded with computer program instructions for performing some or all of the stages of FIG. 1 (e.g., stage 106 only, where stages 102 and 104 are performed before the medium is encoded, and the medium is encoded with the results of stages 102 and 104). The carrier medium may be, for example, solid-state memory, optical or magneto-optical memory such as a readable and/or writable disk for example a compact disk (CD) or a digital versatile disk (DVD), or magnetic memory such as disc or tape, and the computer system can utilize the program to configure it for operation. The computer program may also be supplied from a remote source embodied in a carrier medium such as an electronic signal, including a radio frequency carrier wave or an optical carrier wave.

Application Example: Prostate Cancer Recurrence Study

By way of illustration, and not of limitation, a study was performed in which an embodiment of the present invention was used to predict whether a patient who underwent a prostatectomy was likely to experience early recurrence (class 1) or late recurrence (class 2) of prostate cancer. The particular embodiment of the invention used in this study generated probabilistic patterns through the use of the above-described statistical criteria including parameters h, g, and k, generated pattern-coded data, and scored the pattern-coded data through the use of the above-described ordering and ranking procedure. Notably, conventional uses of the ordering and ranking procedure described in [5] and [6] are not well suited for the support of medical decisions. This is because the ordering and ranking procedure typically cannot be applied unless each data variable is directly correlated with an outcome and, commonly, medical variables are not so correlated. The present invention overcomes this obstacle by generating aggregated oriented variables (i.e., probabilistic patterns including multiple medical variables that collectively correlate with an outcome) for use in ordering and ranking the patients, and thus provides an effective tool for the support of medical decisions. It will be understood that the present invention may be used to support any other suitable type of medical or non-medical decision. For example, the present invention may be used to assist in medical diagnostics aimed at identifying individuals susceptible to harmful conditions, determining patients who may benefit from a new pharmaceutical drug, and so on.

The goal of the study was to find logical rules between the features (variables) of the patients and their outcomes (i.e., early or late recurrence), in the form of probabilistic medical patterns explaining the outcomes. Fifteen clinical data features for two cohorts of patients were used to train and test the above-described embodiment of the present invention. One cohort had 147 patents, the other cohort had 142 patients, and there was no overlap in patients between the cohorts. In a first test, the first cohort was used as the “training” set (i.e., the set of patients used to generate the patterns) and the second cohort was used as the test set. In a second test, the second cohort was used as the training set and the first cohort was used as the test set. The 15 clinical features which were included in the datasets of the patients and used as the basis for the probabilistic patterns were the following:

| | |
|---|---|
| prsltcd | Ploidy diploid, tetraploid, aneuploid |
| pp.sphas | Ploidy percent in S phase |
| pp.frac | Ploidy proliferation fraction |
| bxgg1 | Dominant biopsy Gleason score |
| bxggtot | Biopsy Gleason grade |
| prepsa | Preoperative PSA (prostate-specific antigen) |
| dre | Palpable on DRE (digital rectal exam) |
| uicc | UICC clinical stage |
| ln | Lymph node status |
| margins | Surgical margin status |
| ece | Extracapsular Invasion |
| svi | Seminal vesicle invasion |
| gg1 | Dominant prostatectomy Gleason score |
| ggtot | Prostatectomy Gleason grade |
| tnm | Clinical TNM stage |

In other examples in the medical context, any other suitable features may be included in the datasets of the patents such as, for example, a combination of clinical features, molecular features, and/or computer-generated morphometric features (e.g., generated from tissue samples or images for patients).

Known patients who recurred more than 60 months after a prostatectomy were classified as having experienced “late recurrence” (class C₂). Patients who had yet to recur in a last recorded observation which took place after 60 months were also classified as having experienced late recurrence. In this way, censored data (i.e., data for patients whose ultimate outcomes are unknown) was transformed into non-censored data (i.e., data for patients with known outcomes). Patients who recurred before 60 months were classified as having experienced “early recurrence” (class C₁). The study excluded patients who had yet to recur but whose last observation occurred before 60 months.

For class C₁, parameters h, g, and k were selected such that each pattern of the class satisfied the following conditions: at least 80% (h) of the known patients satisfying the conditions of the pattern actually experienced early recurrence; at least 25% (g) of the known patients that actually experienced early recurrence satisfied all the conditions of the pattern; and the hypothesis included no more than 4 conditions (k). For class C₂, parameters h, g, and k were selected such that each pattern of the class satisfied the following conditions: at least 97% (h) of the known patients satisfying the conditions of the pattern actually experienced late recurrence; at least 25% (g) of the known patients that actually experienced late recurrence satisfied all the conditions of the pattern; and the pattern included no more than 4 conditions (k).

In the study, a total of 39 patterns were generated that correlated with early recurrence. A total of 64 patterns were generated that correlated with late recurrence. The following are five examples of the early recurrence patterns:
1. Clinical TNM Stage=5
2. Dominant prostatectomy Gleason score>3 Clinical TNM Stage>3
3. Lymph node status=1
4. UICC clinical stage>4 Clinical TNM Stage>3
5. Preoperative PSA (prostate-specific antigen)>11.40 Dominant prostatectomy Gleason score>3 Clinical TNM Stage >2
   The following are three examples of the late recurrence patterns:
1. UICC clinical stage>4 Prostatectomy Gleason grade ≦7 Clinical TNM stage≦3
2. UICC clinical stage>4 Dominant prostatectomy Gleason score≦3 Clinical TNM stage≦4
3. UICC clinical stage>4 Seminal vesicle invasion=0.00 Prostatectomy Gleason grade≦7 Clinical TNM stage≦4
   As shown, these patterns correlate readily-interpretable conditions on the features with outcome (i.e., early or late recurrence) and, therefore, can be easily understood and verified by physicians.

The first test showed that the embodiment of the present invention tested in this example provided a sensitivity of 0.8 and a specificity of 0.66. The second test showed that this embodiment of the present invention provided a sensitivity of 0.79 and a specificity of 0.77. Sensitivity measures the ability of an analytical model to detect a condition (e.g., disease) when the condition is truly present. For example, sensitivity may be described as the proportion of all diseased patients for whom there is a positive result, determined as the number of true positives divided by the sum of true positives and false negatives. Specificity measures the ability of an analytical model to exclude the presence of a condition when the condition is truly not present. For example, specificity may be described as the proportion of non-diseased patients for whom there is a correctly negative result, expressed as the number of true negatives divided by the sum of true negatives and false positives.

For comparison with the present invention, the data from the two cohorts of patients was analyzed by a support vector machine (SVM). In the first test, the SVM provided a sensitivity of 0.65 and a specificity of 0.81. In the second test, the SVM provided a sensitivity of 0.5 and a specificity of 0.87. This demonstrates that the predictive power of the present invention is comparable to, if not more favorable than, the predictive power of SVM. Moreover, the present invention provides transparent decisions with medical meaning and does not “overfit” patient data to known outcomes. In contrast, SVM are susceptible to overfitting and do not provide transparent decisions.

Commercial Embodiments

Depending on the particular application, systems that use various embodiments of the present invention may be implemented in order to support decisions under uncertainty. For example, in order to predict the occurrence of a medical condition in a patient, the present invention may be implemented by suitable computing equipment at a medical diagnostics lab or other facility, where the computing equipment may be operative to receive medical data for a patient and output a score indicative of a classification decision for the patient. The computing equipment may also output information indicative of the patterns used to make the decision or other information, in order to allow a physician to use his/her expertise and training to verify the probabilistic patterns and the decision. The design of suitable computing equipment should be apparent to one of ordinary skill in the art based on the description herein, and therefore will not be further described. Additionally, examples of system architectures for implementing predictive models are described in U.S. patent application Ser. No. 11/080,360, filed Mar. 14, 2005, and entitled “Systems and Methods for Treating, Diagnosing and Predicting the Occurrence of a Medical Condition,” which is hereby incorporated by reference herein in its entirety. The implementation of such architectures (e.g., receiving data for a test case from a remote device) in connection with the present invention should be apparent to one of ordinary skill in the art and therefore will not be further described.

Thus it is seen that methods and systems are provided for the induction and use of probabilistic patterns to support decisions under uncertainty. Although particular embodiments have been disclosed herein in detail, this has been done by way of example for purposes of illustration only, and is not intended to be limiting with respect to the scope of the appended claims, which follow. In particular, it is contemplated by the inventor that various substitutions, alterations, and modifications may be made without departing from the spirit and scope of the invention as defined by the claims. Other aspects, advantages, and modifications are considered to be within the scope of the following claims. The claims presented are representative of the inventions disclosed herein. Other unclaimed inventions are also contemplated. Applicant reserves the right to pursue such inventions in later claims.

The following references, which are referred to in the above description, are all hereby incorporated by reference herein in their entireties.

[1] Book, S. (1977) Statistics. Basic Techniques for Solving Applied Problems. McGraw-Hill, Inc.
[2] Sapir, “A method for constructing plausible hypothesis for attributes of various types,” Automat. Remote Control, 1993. N 11. p.134-142 (English translation) (Translated from Avtomatika i Telemekhanika, No. 11, pp. 1-8, November, 1993, originally submitted Jul. 7, 1992).
[3] Sapir et al., “A toolkit for automated search for the most general and easily interpretable hypotheses in first order logic system,” International Conference on Integration of Knowledge Intensive Multi-Agent Systems. KIMAS'03: 318-323.
[4] Sapir, “Formalization of Induction Logic in Biomedical Research,” 4th International Symposium on Robotics and Automation ISRA'2004. Aug. 25-27, 2004. Queretaro, Mexico. pp. 1-8.
[5] Wittkowski et al., “Combining several ordinal measures in clinical studies,” Stat Med 2004, 23:1579-1592.
[6] Wittkowski U.S. Patent Application Publication No.2003/0182281.

I Claim:

1. A method for the induction and use of probabilistic patterns to support a decision under uncertainty, the method comprising:
generating at least one probabilistic pattern of the form B(x)→C based on data for cases with known classification, where B(x) comprises at least one condition on a variable and C comprises an outcome;
generating pattern-coded data for the cases with known classification and for another case, by evaluating the data for the cases with known classification and data for the other case with the at least one probabilistic pattern; and
using the pattern-coded data to classify the other case.

2. The method of claim 1, wherein said generating at least one probabilistic pattern comprises identifying in the data for the cases with known classification rules of the form B(x)→C that satisfy criteria for statistical significance and generality.

3. The method of claim 2, wherein said statistical significance is determined by a z-test criterion.

4. The method of claim 2, wherein said statistical significance is determined by a chi-squared criterion.

5. The method of claim 1, wherein said generating the at least one probabilistic pattern comprises:
identifying one or more rules B(X)→C from the data for the cases with known classification that satisfy the following a criteria for statistical significance:
$$ν ( B , C ) = \frac{‖ B ( x ) ⋂ C ‖}{‖ C ‖} ; ν ( B , C ) \geq g ,$$
where h and g are constants; and
determining, for each identified rule, whether that rule is the most general rule amongst other rules comparable by generality.

6. The method of claim 5, wherein said generating further comprises identifying rules with no more than k non-trivial conditions on the variable(s).

7. The method of claim 1, wherein said using the pattern-coded data to classify the other case comprises subjecting the pattern-coded data to a multi-dimensional partial ordering and ranking procedure in order to classify the test case.

8. The method of claim 1, wherein said using the pattern-coded data to classify a test case comprises:
determining a score, for each case of the known cases and the test case;
determining a threshold value based on the scores for the known cases; and
comparing the score for the test case to the threshold.

9. A method for using probabilistic patterns to support a decision under uncertainty, the method comprising:
generating pattern-coded data for a case by evaluating if feature data for the case satisfies the premise B(x) of at least one probabilistic pattern of the form B(x)→C, wherein C comprises an outcome; and
classifying the case according to the pattern-coded dataset.

10. The method of claim 9, wherein said classifying the case according to the pattern-coded dataset comprises:
determining a score for the case based on the pattern-coded dataset by subtracting a number of patterns associated with a first class that the case exhibits from a number of patterns associated with a second class that the case exhibits; and
comparing the score to a threshold.

11. The method of claim 9, wherein evaluating feature data comprises evaluating data for one or more clinical features, one or more molecular features, and one or more computer-generated morphometric features.

12. A system for the induction and use of probabilistic patterns to support a decision under uncertainty, the system comprising processing circuitry configured to:
generate at least one probabilistic pattern of the form B(x)→C based on data for cases with known classification, where B(x) comprises at least one condition on a variable and C comprises an outcome;
generate pattern-coded data for the cases with known classification and for another case, by evaluating the data for the cases with known classification and data for the other case with the at least one probabilistic pattern; and
use the pattern-coded data to classify the other case.

13. The system of claim 12, wherein said processing circuitry configured to generate at least one probabilistic pattern comprises processing circuitry configured to identify in the data for the cases with known classification rules of the form B(x)→C that satisfy criteria for statistical significance and generality.

14. The system of claim 13, wherein said statistical significance is determined by a z-test criteria.

15. The system of claim 13, wherein said statistical significance is determined by a chi-squared criteria.

16. The system of claim 12, wherein said processing circuitry configured to generate the at least one probabilistic pattern comprises processing circuitry configured to:
identify one or more rules B(X)→C from the data for the cases with known classification that satisfy the following a criteria for statistical significance:
$$μ ( B , C ) = \frac{‖ B ( x ) ⋂ C ‖}{‖ B ( x ) ‖} ; μ ( B , C ) \geq h , and$$
$$ν ( B , C ) = \frac{‖ B ( x ) ⋂ C ‖}{‖ C ‖} ; ν ( B , C ) \geq g ,$$
where h and g are constants; and
determine, for each identified rule, whether that dependency is the most general rule amongst other rules comparable by generality.

17. The system of claim 16, wherein said processing circuitry configured to generate the at least one probabilistic pattern is further configured to identify rules with no more than k non-trivial conditions on the variable(s).

18. The system of claim 12, wherein said processing circuitry configured to use the pattern-coded data to classify a test case is configured to subject the pattern-coded data to a multi-dimensional partial ordering and ranking procedure in order to classify the test case.

19. The system of claim 12, wherein said processing circuitry configured to use the pattern-coded data to classify a test case is configured to:
determine a score, for each case of the known cases and the test case;
determine a threshold value based on the scores for the known cases; and
compare the score for the test case to the threshold.

20. A system for predicting an outcome for a case, the system comprising processing circuitry configured to:
generate pattern-coded data for a case by evaluating if feature data for the case satisfies the premise B(x) of at least one probabilistic pattern of the form B(x)→C, wherein C comprises an outcome; and
classifying the case according to the pattern-coded dataset.

21. The system of claim 20, wherein said processing circuitry configured to classify the case is configured to:
determine a score for the case based on the pattern-coded dataset by subtracting a number of patterns associated with a first class that the case exhibits from a number of patterns associated with a second class that the case exhibits; and
comparing the score to a threshold.

22. The system of claim 20, wherein said feature data comprises one or more clinical features, one or more molecular features, and one or more computer-generated morphometric features.

23. Computer-readable medium encoded with computer program instructions for performing the method comprising:
generating at least one probabilistic pattern of the form B(x)→C based on data for cases with known classification, where B(x) comprises at least one condition on a variable and C comprises an outcome;
generating pattern-coded data for the cases with known classification and for another case, by evaluating the data for the cases with known classification and data for the other case with the at least one probabilistic pattern; and
using the pattern-coded data to classify the other case.

24. The computer-readable medium of claim 23, wherein said generating at least one probabilistic pattern comprises identifying in the data for the cases with known classification rules of the form B(x)→C that satisfy criteria for statistical significance and generality.
